(19) United States
(12) Patent Application Publication
(10) Pub. No.: US 2014/0094197 A1
(43) Pub. Date: Apr. 3, 2014

(54) SPEED AND TOPOLOGY RELEVANT DYNAMIC GEO SEARCH

(71) Applicant: fisoc, Inc., Austin, TX (US)

(72) Inventors: Daniel Edward Kim, Austin, TX (US); Marshal Hernandez, Leander, TX (US); Jay P. Valanju, Austin, TX (US); David H. Fruhling, II, Austin, TX (US)

(73) Assignee: fisoc, Inc., Austin, TX (US)

(21) Appl. No.: 14/045,080

(22) Filed: Oct. 3, 2013

Related U.S. Application Data
(60) Provisional application No. 61/709,283, filed on Oct. 3, 2012.

(51) Int. Cl. H04W 4/02

(52) U.S. Cl. CPC H04W 4/028
USPC 455/456.3

(57) ABSTRACT

A geographic searching system and method for a mobile terminal provides for accessible search results based on spatial characteristics of the mobile terminal. A displacement distance is established for a look-ahead search region, and the look-ahead search region is defined using a location-determination module of the mobile terminal and based on the spatial characteristics of the mobile terminal Relevant points of interest within the look-ahead search region are identified.

### CROSS-REFERENCES TO RELATED APPLICATIONS

This application claims the benefit of U.S. Provisional Patent Application Ser. No. 61/709,283, filed Oct. 3, 2012, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The invention relates to searching for points of interest with a mobile terminal and, more particularly, to a geographic searching system and method for a mobile terminal that provides speed and topology relevant results.

In searching for points of interest using a mobile terminal, such as a cell phone or the like, existing systems typically search for relevant points of interest based on proximity to the mobile terminal. One problem with existing systems, however, is that if the user is in a moving vehicle, identifying points of interest such as a gas station, restaurant or the like, that is close but behind the user is undesirable. Travelers are unlikely to turn around, which would result in unnecessary travel delays. Likewise, if the traveler is moving at different speeds, such as by motorized vehicle versus by bicycle, the default search distance should be varied

It would thus be desirable for a system that could limit the search result to points of interest that are located ahead of the user. It would also be desirable to identify points of interest that are far enough ahead that the user has time to decide on and navigate to a selected location.

### BRIEF SUMMARY OF THE INVENTION

Deficiencies of the prior art can be overcome by performing geographic searches using look-ahead search regions that consider a speed and direction of travel of a moving vehicle. In addition, as described in detail below, geographic searching can be further improved by considering topological features when constructing look-ahead search regions.

In an exemplary embodiment, a geographic searching method includes the steps of (a) determining a location, a speed of travel, and a direction of travel of a mobile terminal using a location-determination module on the mobile terminal; (b) communicating the location, the speed of travel and the direction of travel to a server over a global network; (c) the server defining a look-ahead search region based on the location, the speed of travel and the direction of travel of the mobile terminal, the look-ahead search region being spaced from the location of the mobile terminal by displacement distance that is either predefined or is dependent on the speed of travel; (d) the server accessing a location database including points of interest; and (e) the server acquiring relevant points of interest within the look-ahead search region.

The displacement distance may be determined as a function of time. Step (c) may be practiced such that the look-ahead search region includes a search angle and a search distance determined according to the speed of travel. The search angle may vary linearly between a predefined minimum angle and a predefined maximum angle based on the speed of travel. In one embodiment, the predefined minimum angle is 45° and the predefined maximum angle is 360°. Alternatively, the search angle may be 45° for speeds greater than or equal to a predetermined high speed, and 360° for speeds less than or equal to a predetermined low speed. The search distance may be a function of time based on the speed of travel.

Step (c) may be further practiced by shifting the look-ahead search region according to topological features. The topological features may be locations of highway exits. In this context, the step of shifting the look-ahead search region may include shifting the look-ahead search region toward a highway exit location. Alternatively, the step of shifting the look-ahead search region may include shifting the look-head search region clockwise relative to the direction of travel. The step of shifting the look-ahead search region may still alternately include rotating the look-ahead search region such that one side of the look-ahead search region is substantially parallel with the direction of travel. In some embodiments, an amount of shifting is dependent on the search angle.

In another exemplary embodiment, a geographic searching method for a mobile terminal includes the steps of (a) establishing a displacement distance for a look-ahead search region; (b) defining the look-ahead search region using a location-determination module of the mobile terminal and based on spatial characteristics of the mobile terminal; and (c) the mobile terminal communicating relevant points of interest within the look-ahead search region. Step (b) may be practiced using a GPS receiver.

In yet another exemplary embodiment, a system for geographic searching with a mobile terminal includes a location-determination module resident on the mobile terminal that identifies spatial characteristics of the mobile terminal, and a processor programmed to establish a displacement distance for a look-ahead search region. The processor is also programmed to define the look-ahead search region using the location-determination module of the mobile terminal and based on the spatial characteristics of the mobile terminal. A location database includes geographic points of interest. Relevant points of interest within the look-ahead search region are identified from the geographic points of interest in the location database. The system may additionally include a server computer communicating with the mobile terminal over a global network. The server computer includes the processor and is programmed to access the location database and communicate the relevant points of interest to the mobile terminal.

### BRIEF DESCRIPTION OF THE DRAWINGS

A more complete understanding of the method and apparatus of the present invention may be obtained by reference to the following detailed description when taken in conjunction with the accompanying drawings, in which:

FIG. 1 illustrates a system for geographic searching;

FIG. 2 is a sequence diagram relative to the system of FIG. 1;

FIG. 3 illustrates a look-ahead search region; and

FIG. 4 illustrates a topology-relevant look-ahead search region.

### DETAILED DESCRIPTION OF THE INVENTION

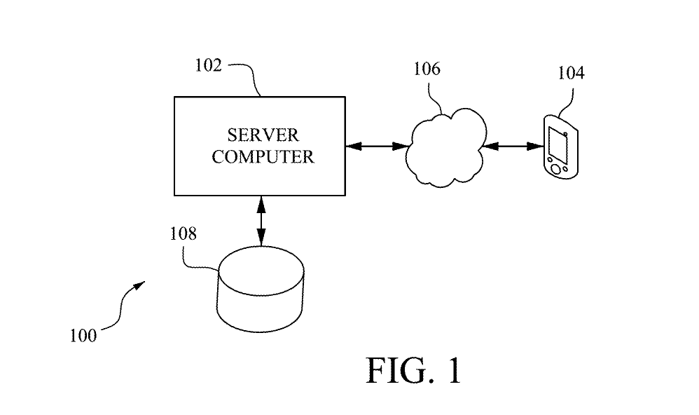

FIG. 1 illustrates a system 100 for geographic searching The system 100 includes a server computer 102, a network 106 such as, for example, the Internet, a mobile terminal 104, and a location database 108. The server computer 102 may be representative of any number of physical or virtual server computers. In a similar fashion, the mobile terminal 104 may be representative of any number of mobile terminals operable to determine a physical location and transmit the physical location to the server computer 102. For example, in various embodiments, the mobile terminal 104 can be a smartphone, tablet, laptop computer, a standalone global positioning system (GPS) device, an installed computer on a vehicle, or the like.

The mobile terminal 104 is configured to communicate location information to the server computer 102 at desired intervals. In a typical embodiment, the mobile terminal 104 has a native application loaded thereon that uses the location information in order to acquire nearby points of interest and present the nearby points of interest on display for viewing by a user. The points of interest may include filters specified by the user to include, for example, restaurants, gas stations, supermarkets, movie theaters, etc. In a typical embodiment, via the native application or another interface, the user of the mobile terminal 104 can enter criteria for points of interest with desired specificity.

In various embodiments, the native application on the mobile terminal 104 utilizes location-determination capabilities of the mobile terminal 104 to determine a physical location and to transmit the physical location to the server computer 102. Those of ordinary skill in the art will appreciate that the mobile terminal 104 may include various types of location-determination capabilities. For example, the mobile terminal 104 can be equipped with a GPS receiver or be operable to determine the physical location through signal measurements such as, for example, angle of approach to cell towers, length of time for a signal to travel to multiple cell towers, or strength of a signal. In various embodiments, the physical location may be transmitted to the server computer 102 at regular intervals (e.g. every minute) or on demand responsive to a request for points of interest.

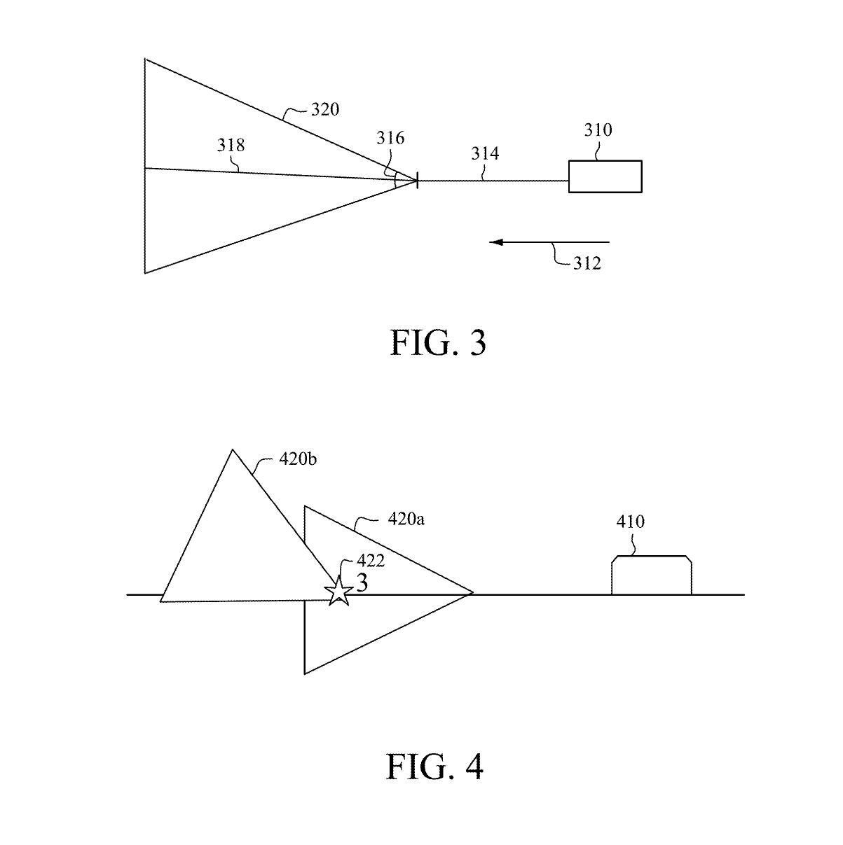

Upon receipt of location information from the mobile terminal 104, the server computer 102 computer is operable to dynamically construct a look-ahead search region based on spatial characteristics of the mobile terminal 104 including, for example, speed and direction of travel. The look-ahead search region specifies an area in which it is desired to find points of interest. Construction of the look-ahead region will be described in greater detail with reference to FIGS. 3 and 4.

The location database 108 serves as a repository for points of interest. In particular, the location database 108 maintains geographic coordinates for the points of interest stored therein. The location database 108 is operable to receive geographic coordinates defining the look-ahead search region and return points of interest (and related data) to the server computer 102.

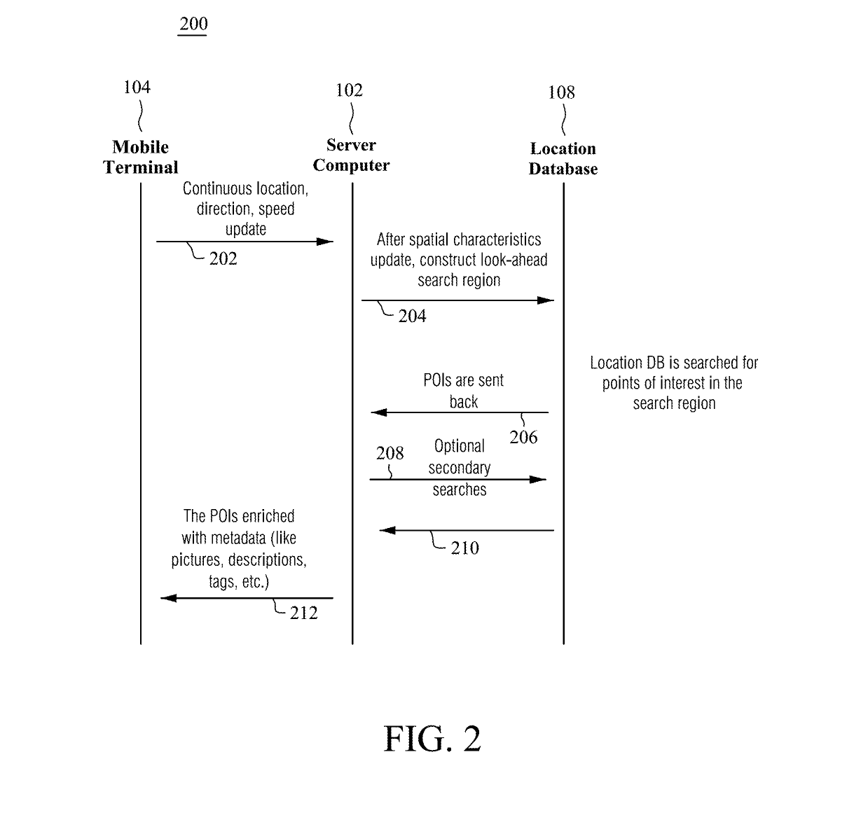

FIG. 2 is a sequence diagram 200 relative to the system 100 of FIG. 1. At step 202, the mobile terminal 104 provides continuous spatial characteristics including location information and speed information at frequent intervals (e.g., once per minute). When receiving an update, at step 204, the server computer 102 constructs a look-ahead search region based on a location of the mobile device 104. The server computer 102 searches the location database 108 for points of interest that are located within the look-ahead search region. At step 206, the server computer 102 receives points of interests that are located within the look-ahead search region from the location database 108. Optionally, at step 208, additional secondary searches may be conducted if, for example, the look-ahead search region failed to yield points of interest. For example, the look-ahead search region may be expanded. In an alternative arrangement, the system may be self-contained in the mobile terminal 104. That is, the mobile terminal 104 may typically include an onboard processor that can be programmed to define the look-ahead search region. Additionally, the mobile terminal 104 may include its own database of points of interest such that the entire system and methodology can be self-contained without requiring access to the Internet or a remote server computer.

FIGS. 3-4 illustrate in greater detail how a look-ahead search region can be constructed. FIG. 3 depicts a look-ahead search region 320 relative to a moving vehicle 310 that is moving in a direction of travel 312. In a typical embodiment, the moving vehicle 310 includes a mobile terminal such as, for example, the mobile terminal 104 of FIG. 1. For example, the mobile terminal may be a smartphone in possession of a user who is riding in the moving vehicle 310. Although speed and location are determined specifically with respect to the mobile terminal 104, for purposes of convenience and clarity, FIG. 3 will be described relative to the moving vehicle 310 within which the mobile terminal 104 is located. As described in more detail below, the look-ahead search region 320 is defined by a displacement distance 314, a search distance 318, and a search angle 316.

The displacement distance 314 is a predefined distance ahead in the direction of travel 312. In a typical embodiment, the displacement distance 314 allows a driver of the moving vehicle 310 at least minimal time to review, plan, and react prior to reaching identified points of interest. In a typical embodiment, the displacement distance 314 is calculated as a function of time. For example, if it is desired that the look-ahead search region 320 be five minutes ahead and the moving vehicle 310 is traveling at 60 miles per hour (MPH) in the direction of travel 312, the displacement distance 314 would be five miles. According to this example, the look-ahead search region 320 would begin five miles ahead in the direction of travel 312 (using the most recent location).

The search angle 316 is also determined as a function of the speed of the moving vehicle 310. In a typical embodiment, the search angle 316 varies linearly between predefined minimum and maximum search angles; however, it should be appreciated that any function that establishes a relationship can be used (e.g., a logarithmic function). A function can be crafted and configured according to the requirements of a particular implementation. For example, in one embodiment, the search angle 316 varies linearly between 45 degrees and 360 degrees. In this embodiment, the search angle 316 is 45 degrees for speeds greater than or equal to a predetermined maximum speed, for example 60 MPH. In a similar fashion, the search angle 316 is 360 degrees for speeds less than or equal to a predetermined minimum speed, for example 4.5 MPH. According to this embodiment, the search angle 316 varies linearly for speeds between 60 MPH and 4.5 MPH. This results in the search angle 316 being a circle for lower speeds and more triangular for higher speeds.

The search distance 318 is determined as a function of the speed of the moving vehicle 310 and a desired period of time (and is therefore also configurable). For example, in some embodiments, if the moving vehicle 310 is traveling at 60 MPH and a five minute search is desired, the search distance would be five miles.

In various embodiments, when the search angle 316 is less than a predefined value such as, for example, 180 degrees, the look-ahead search region 320 is a triangle defined by the search angle 316 and the search distance 318. In these embodiments, the search distance 318 serves as a height of the triangle. In a typical embodiment, when the search angle 316 equals or exceeds the predefined value (e.g., 180 degrees), the look-ahead search region 320 is either a circle or a sector of a circle. This is an optimization that allows the search to be completed with a more complex “round” search. For example, if the search angle 316 equals 360 degrees, the look-ahead search region 320 is a full circle having the search distance 318 as a radius. Otherwise, if the search angle 316 is greater than or equal to the predefined value (e.g., 180 degrees) but less than 360 degrees, the search angle 316 is a proportional sector of a full circle having the search distance 318 as a radius.

While the look-ahead search region 320 of FIG. 3 offers numerous benefits, moving vehicles such as the moving vehicle 310 often travel on highways with specified points of entry and exit. The lack of an appropriately-positioned highway exit can cause a portion of the look-ahead search region 320 to be inconvenient to access. For example, it may not be possible to drive to some points of interest within the look-ahead search region 320 without first passing the points of interest, taking the next exit, and turning around twice. Consequently, a topology-relevant geographic search region that considers topological features such as, for example, locations of highway exits, can offer further advantages to geographic searching.

FIG. 4 illustrates an example of how a topology-relevant geographic search region 420b can be constructed. For comparison purposes, FIG. 4 illustrates both a look-ahead search region 420a and a topology-relevant look-ahead search region 420b. FIG. 4 further depicts a moving vehicle 410 and a topological feature 422. The moving vehicle 410 is generally similar to the moving vehicle 310 described above with respect to FIG. 3. In addition, the look-ahead search region 420a is constructed similarly to the look-ahead search region 320 of FIG. 3.

The topology-relevant look-ahead search region 420b generally differs from the look-ahead search region 420a only by its orientation. In particular, the topology-relevant look-ahead search region 420b is identical to the look-ahead search region 420a except that the topology-relevant look-ahead search region 420b is shifted forward (clockwise in FIG. 4) to the topology feature 422 which may be, for example, a highway exit. Optionally and as shown in FIG. 4, the topology-relevant look-ahead search region 420b can additionally be rotated to favor points of interest on a “right” side of the highway relative to the direction of travel of the moving vehicle 410. In that way, the topology-relevant look-ahead search region 420b can result in points of interest that are more conveniently accessible by minimizing the need for a driver to cross an opposite, or “left,” side of the highway. As shown in FIG. 4, the topology-relevant look-ahead search region 420b may be rotated so that a side thereof is parallel to a direction of travel. When a search angle such as, for example, the search angle 316 of FIG. 3, is greater than or equal to a predefined value (e.g., 180 degrees), the topology-relevant look-ahead search region 420b is not typically rotated.

Using the look-ahead search region provides for more accessible and relevant search results for geographic point of interest searches. The system utilizes spatial characteristics of the mobile terminal to identify relevant points of interest that are most convenient to a traveling user. The system and methodology also accommodate topological features to provide still more relevant and accessible results.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A geographic searching method comprising:
(a) determining a location, a speed of travel, and a direction of travel of a mobile terminal using a location-determination module on the mobile terminal;
(b) communicating the location, the speed of travel and the direction of travel to a server over a global network;
(c) the server defining a look-ahead search region based on the location, the speed of travel and the direction of travel of the mobile terminal, the look-ahead search region being spaced from the location of the mobile terminal by displacement distance that is either predefined or is dependent on the speed of travel;
(d) the server accessing a location database including points of interest; and
(e) the server acquiring relevant points of interest within the look-ahead search region.

2. A geographic searching method according to claim 1, wherein the displacement distance is dependent on the speed of travel.

3. A geographic searching method according to claim 1, wherein the displacement distance is determined as a function of time.

4. A geographic searching method according to claim 1, wherein step (c) is practiced such that the look-ahead search region comprises a search angle and a search distance determined according to the speed of travel.

5. A geographic searching method according to claim 4, wherein the search angle varies linearly between a predefined minimum angle and a predefined maximum angle based on the speed of travel.

6. A geographic searching method according to claim 5, wherein the predefined minimum angle is 45° and the predefined maximum angle is 360°.

7. A geographic searching method according to claim 4, wherein the search angle is 45° for speeds greater than or equal to a predetermined high speed, and wherein the angle is 360° for speeds less than or equal to a predetermined low speed.

8. A geographic searching method according to claim 4, wherein the search distance is a function of time based on the speed of travel.

9. A geographic searching method according to claim 4, wherein step (c) is further practiced by shifting the look-ahead search region according to topological features.

10. A geographic searching method according to claim 9, wherein the topological features comprise locations of highway exits.

11. A geographic searching method according to claim 10, wherein the step of shifting the look-ahead search region comprises shifting the look-ahead search region toward a highway exit location.

12. A geographic searching method according to claim 9, wherein the step of shifting the look-ahead search region comprises shifting the look-head search region clockwise relative to the direction of travel.

13. A geographic searching method according to claim 9, wherein the step of shifting the look-ahead search region comprises rotating the look-ahead search region such that one side of the look-ahead search region is substantially parallel with the direction of travel.

14. A geographic searching method according to claim 9, wherein an amount of shifting is dependent on the search angle.

15. A geographic searching method for a mobile terminal, the method comprising:
(a) establishing a displacement distance for a look-ahead search region;
(b) defining the look-ahead search region using a location-determination module of the mobile terminal and based on spatial characteristics of the mobile terminal; and
(c) the mobile terminal communicating relevant points of interest within the look-ahead search region.

16. A geographic searching method according to claim 15, wherein step (b) is practiced using a GPS receiver.

17. A system for geographic searching with a mobile terminal, comprising:
a location-determination module resident on the mobile terminal, the location-determination module identifying spatial characteristics of the mobile terminal;
a processor programmed to establish a displacement distance for a look-ahead search region, the processor being programmed to define the look-ahead search region using the location-determination module of the mobile terminal and based on the spatial characteristics of the mobile terminal; and
a location database including geographic points of interest, wherein relevant points of interest within the look-ahead search region are identified from the geographic points of interest in the location database.

18. A system for geographic searching according to claim 17, further comprising a server computer communicating with the mobile terminal over a global network, the server computer comprising the processor, wherein the server computer is programmed to access the location database and communicate the relevant points of interest to the mobile terminal.

19. A system for geographic searching according to claim 17, wherein the look-ahead search region comprises a search angle and a search distance determined according to the spatial characteristics.

20. A system for geographic searching according to claim 17, wherein the processor is programmed to shift the look-ahead search region according to topological features.
